(19) United States
(12) Patent Application Publication
(10) Pub. No.: US 2021/0304606 A1
(43) Pub. Date: Sep. 30, 2021

(54) ACCOMMODATION AREA MANAGEMENT DEVICE

(71) Applicant: HONDA MOTOR CO., LTD., Tokyo (JP)

(72) Inventors: Junpei NOGUCHI, Saitama (JP); Gaku SHIMAMOTO, Saitama (JP); Yuta TAKADA, Tokyo (JP); Ryoma TAGUCHI, Tokyo (JP)

(73) Assignee: HONDA MOTOR CO., LTD., Tokyo (JP)

(21) Appl. No.: 17/212,783

(22) Filed: Mar. 25, 2021

(30) Foreign Application Priority Data
Mar. 30, 2020 (JP) 2020-061641

(51) Int. Cl. G08G 1/14; B60W 30/06; G06K 9/00

(52) U.S. Cl. CPC G08G 1/148; G06K 9/00838; B60W 30/06; G08G 1/149

(57) ABSTRACT

An accommodation area management device which manages an accommodation area capable of accommodating a moving body includes an acquisition unit configured to acquire information on the moving body, a determination unit configured to determine whether the moving body satisfies a condition of not allowing entry into the accommodation area based on the information on the moving body, and a processing unit configured to instruct the outside of the accommodation area as a destination when it is determined that the moving body satisfies the condition of not allowing entry into the accommodation area.

### CROSS-REFERENCE TO RELATED APPLICATIONS

This application is based upon and claims the benefit of priority from prior Japanese patent application No. 2020-061641, filed on Mar. 30, 2020, the entire contents of which are incorporated herein by reference.

### TECHNICAL FIELD

The present invention relates to an accommodation area management device which manages an accommodation area capable of accommodating a moving body.

### BACKGROUND ART

In a recent year, there is known a technique for preventing occurrence of leaving something behind in an autonomous vehicle. For example, JP-A-2019-156067 describes a technique for preventing a vehicle from being started at discretion of the vehicle when something left behind is detected in a vehicle interior of an autonomous driving vehicle.

However, in the prior art, a moving body which does not satisfy a predetermined criterion may enter an accommodation area capable of accommodating a moving body such as a vehicle, and thus there is room for improvement from a viewpoint of appropriately managing the accommodation area. For example, in a parking lot system where a parking lot management device makes an autonomous vehicle move to a parking space, when the behavior of the vehicle cannot be controlled by determination of the parking lot system regardless of determination of the vehicle, the parking space cannot be managed properly.

### SUMMARY OF INVENTION

The invention provides an accommodation area management device capable of appropriately managing an accommodation area by suppressing entry of a moving body which does not satisfy a predetermined criterion into the accommodation area.

According to an aspect of the present invention, there is provided an accommodation area management device which manages an accommodation area capable of accommodating a moving body. The accommodation area management device includes an acquisition unit configured to acquire information on the moving body, a determination unit configured to determine whether the moving body satisfies a condition of not allowing entry into the accommodation area based on the information on the moving body, and a processing unit configured to instruct the outside of the accommodation area as a destination when it is determined that the moving body satisfies the condition of not allowing entry into the accommodation area.

According to the invention, the moving body which satisfies the condition of not allowing entry into the accommodation area is instructed to set the outside of the accommodation area as the destination. Therefore, it suppresses the moving body from entering the accommodation area, and thus it possible to manage the accommodation area appropriately.

### BRIEF DESCRIPTION OF DRAWINGS

FIG. 1 is a diagram illustrating an example of a configuration of a vehicle system of an embodiment.

FIG. 2 is a diagram illustrating an example of a parking lot managed by a parking lot management device.

FIG. 3 is a diagram illustrating an example of a configuration of the parking lot management device.

FIG. 4 is a diagram illustrating an example of a parking space information table.

FIG. 5 is a diagram illustrating an example of an entry restriction condition table.

FIG. 6 is a flowchart illustrating an example of a vehicle entry control process performed by the parking lot management device.

FIG. 7 is a diagram illustrating another example of the parking lot managed by the parking lot management device.

### DESCRIPTION OF EMBODIMENT

Hereinafter, an embodiment of a parking lot management device of the invention will be described with reference to the accompanying drawings. In a following description of the embodiment, an example will be described in which a moving body in the invention is a vehicle such as an automobile and an accommodation area in the invention is a parking space in a parking lot.

First, the vehicle of the embodiment will be described. The vehicle (hereinafter, also referred to as vehicle M) of the embodiment is a vehicle having a drive source and wheels (for example, two wheels, three wheels, or four wheels) including driving wheels driven by power of the drive source. The drive source of the vehicle M is, for example, an electric motor. Further, the drive source of the vehicle M may be an internal combustion engine such as a gasoline engine or a combination of an electric motor and an internal combustion engine.

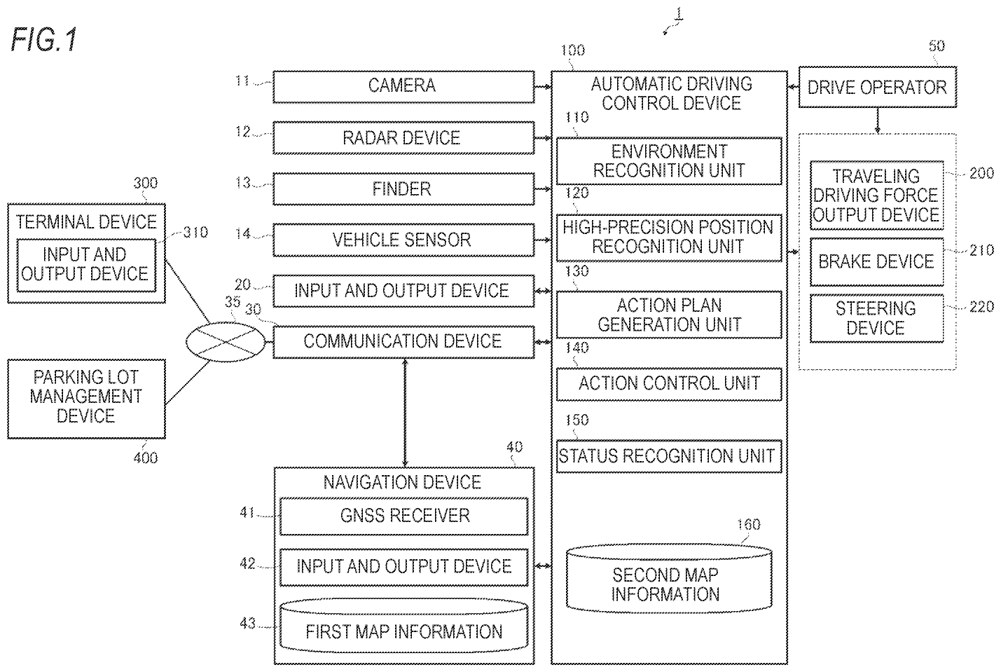

The vehicle M is equipped with a vehicle system 1 illustrated in FIG. 1. The vehicle system 1 has a function capable of performing all driving tasks related to the vehicle M, at least within a limited specific area (for example, in parking lot PA described below). Here, the driving task is, for example, a real-time driving function necessary for maneuvering the vehicle M such as controlling a left-right movement (steering) of the vehicle M, controlling a forward-backward movement (acceleration, deceleration), and monitoring the driving environment, and a tactical function such as planning a traveling track.

As illustrated in FIG. 1, the vehicle system 1 includes, for example, a camera 11, a radar device 12, a finder 13, a vehicle sensor 14, an input and output device 20, a communication device 30, a navigation device 40, a drive operator 50, an automatic driving control device 100, a traveling driving force output device 200, a brake device 210, a steering device 220. Each of those devices is communicably connected to each other by a wired or wireless communication network. The communication network connecting each of those devices is, for example, Controller Area Network (CAN).

The camera 11 includes a digital camera which photographs the periphery (for example, in front of the vehicle M) of the vehicle M and a digital camera which photographs the passenger compartment of the vehicle M. The camera 11 outputs image data obtained by the photographing to the automatic driving control device 100.

The radar device 12 is, for example, a radar device using radio waves in a millimeter wave band, detects a position of an object in the vicinity (for example, in front of, behind, and to the side of the vehicle M) of the vehicle M, and outputs the detection result to the automatic driving control device 100.

The finder 13 is, for example, Laser Imaging Detection and Ranging (LIDAR). The finder 13 uses a predetermined laser beam to measure the distance to an object (target object) around (for example, in front of, behind, and to the side of vehicle M) the vehicle M and outputs the measurement result to the automatic driving control device 100.

The vehicle sensor 14 includes, for example, a vehicle speed sensor which detects the speed of the vehicle M, an acceleration sensor which detects the acceleration of the vehicle M, an angular velocity sensor which detects the angular velocity around a vertical axis of the vehicle M, an orientation sensor which detects the orientation of the vehicle M, and the like. Further, the vehicle sensor 14 includes a radio wave intensity sensor which detects the radio wave intensity (that is, the communication environment) used by the communication device 30 for communication. The vehicle sensor 14 outputs the detection result of each sensor to the automatic driving control device 100.

The input and output device 20 includes an output device which outputs various kinds of information to a user of the vehicle M and an input device which accepts various input operations from a user. The output device of the input and output device 20 is, for example, a display which displays based on a processing result of the automatic driving control device 100. The output device may be a speaker, a buzzer, an indicator light, or the like. Further, the input device of the input and output device 20 is, for example, a touch panel or an operation button (key, switch, or the like) which outputs an operation signal corresponding to an input operation received from a user to the automatic driving control device 100.

The communication device 30 is wirelessly connected to a network 35 and communicates with another device provided outside the vehicle system 1 via the network 35. The network 35 includes, for example, a mobile communication network, a Wi-Fi network, Bluetooth (registered trademark), Dedicated Short Range Communication (DSRC), and the like.

The communication device 30 communicates with, for example, a terminal device 300 carried by a user of the vehicle M. The terminal device 300 is, for example, a smartphone or a tablet terminal and is an electronic device connected to the network 35 and including an input and output device 310. The input and output device 310 is, for example, a display which displays various kinds of information to a user, a touch panel which accepts a user's input operation, and the like.

The navigation device 40 includes a Global Navigation Satellite System (GNSS) receiver 41 and an input and output device 42. Further, the navigation device 40 includes a storage device (not illustrated) such as a hard disk drive (hereinafter, also referred to as HDD) and a flash memory and first map information 43 is stored in this storage device. The first map information 43 is, for example, information representing a road shape by a link indicating a road and a node connected by the link. Further, the first map information 43 may include information representing the curvature of the road and the Point Of Interest (POI).

The GNSS receiver 41 identifies the latitude and longitude of a point where the vehicle M is located as the position of the vehicle M based on the signal received from the GNSS satellite. Further, the navigation device 40 may specify or correct the position of the vehicle M by an Inertial Navigation System (INS) using the output of the vehicle sensor 14.

The input and output device 42 includes an output device which outputs various kinds of information to a user and an input device which accepts various input operations from a user. The output device of the input and output device 42 is, for example, a display which displays (for example, displays a route on a map described below) based on the processing result of the navigation device 40. Further, the input device of the input and output device 42 is, for example, a touch panel or an operation button (key, switch, or the like) which outputs an operation signal corresponding to the input operation received from a user to the navigation device 40. The input and output device 42 may be shared with the input and output device 20.

Although detailed description is omitted, the navigation device 40 determines, for example, a route (hereafter, also referred to as the route on the map) from the position of the vehicle M specified by the GNSS receiver 41 to a destination input by a user with reference to the first map information 43. Then, the navigation device 40 guides a user on the determined route on the map by the input and output device 42.

Some or all of the functions of the navigation device 40 may be realized by the terminal device 300. Further, some or all of the functions of the navigation device 40 may be realized by an external server (navigation server) capable of communicating with the vehicle system 1 by the communication device 30 or the like.

The drive operator 50 is various operators such as an accelerator pedal, a brake pedal, a shift lever, a steering wheel, a deformed steering wheel, and a joystick. The drive operator 50 is provided with a sensor which detects the amount of operation or the presence or absence of operation on the drive operator 50. The detection result by the sensor of the drive operator 50 is output to a part or all of the automatic driving control device 100, the traveling driving force output device 200, the brake device 210, and the steering device 220.

The traveling driving force output device 200 outputs a traveling driving force (torque) for the vehicle M to travel to the driving wheels. The traveling driving force output device 200 includes, for example, an electric motor and an electric motor Electronic Control Unit (ECU) which controls the electric motor. The electric motor ECU controls the electric motor based on the detection result by the sensor of the drive operator 50 (for example, the accelerator pedal) and the control information from the automatic driving control device 100. Further, when the vehicle M includes an internal combustion engine or a transmission as a drive source, the traveling driving force output device 200 may include an internal combustion engine or a transmission and an ECU for controlling the internal combustion engine or the transmission.

The brake device 210 includes, for example, a brake caliper, a cylinder which transmits hydraulic pressure to the brake caliper, an electric motor which generates hydraulic pressure in the cylinder, and a brake ECU. Based on the detection result by the sensor of the drive operator 50 (for example, the brake pedal) and the control information from the automatic driving control device 100, the brake ECU controls the electric motor of the brake device 210 so that the brake torque corresponding to the braking operation is output to each wheel.

The steering device 220 includes, for example, a steering ECU and an electric motor. The electric motor of the steering device 220, for example, applies a force to the rack and pinion mechanism to change the direction of the steering wheel. Based on the detection result by the sensor of the drive operator 50 (for example, the steering wheel) and the control information from the automatic driving control device 100, the steering ECU drives the electric motor of the steering device 220 to change the direction (that is, the steering angle) of the steering wheels.

The automatic driving control device 100 includes an environment recognition unit 110, a high-precision position recognition unit 120, an action plan generation unit 130, an action control unit 140, and a status recognition unit 150. Further, the automatic driving control device 100 includes a storage device (not illustrated) realized by a flash memory or the like to which each functional unit (for example, high-precision position recognition unit 120) of the automatic driving control device 100 can access and second map information 160 is stored in this storage device.

The second map information 160 is map information with higher accuracy than the first map information 43. The second map information 160 includes, for example, information indicating a center of a lane, information indicating a lane boundary line (for example, a road lane marking), and the like. Further, the second map information 160 may include road information, traffic regulation information, address information, facility information, telephone number information, and the like.

Further, the second map information 160 may be updated at any time by the communication device 30 communicating with another device. For example, when the vehicle M enters the parking lot PA, the communication device 30 receives information (hereafter, also referred to as in-parking-lot map information) indicating the line in the parking lot PA, the position of each parking space, and the like from a parking lot management device 400. Then, the automatic driving control device 100 updates the second map information 160 so as to incorporate the received in-parking-lot map information into the second map information 160. Thereby, the automatic driving control device 100 can specify the position of each parking space PS in the parking lot PA or the like with reference to the second map information 160.

The environment recognition unit 110 performs sensor fusion processing on information acquired by a part or all of the camera 11, the radar device 12, and the finder 13, in such a manner that the environment recognition unit 110 recognizes an object around the vehicle M and recognizes its position. The environment recognition unit 110 recognizes, for example, an obstacle, a road shape, a traffic light, a guardrail, a utility pole, a surrounding vehicle (including traveling conditions such as speed and acceleration and parking conditions), a lane mark, a pedestrian, and the like and recognizes their positions.

Referring to the position of the vehicle M specified by the navigation device 40, the detection result by the vehicle sensor 14, the image taken by the camera 11, the second map information, and the like, the high-precision position recognition unit 120 recognizes the detailed position and attitude of the vehicle M. The high-precision position recognition unit 120 recognizes, for example, the traveling lane in which the vehicle M is traveling or recognizes the relative position and attitude of the own vehicle with respect to the traveling lane. Further, the high-precision position recognition unit 120 also recognizes, for example, the position of the vehicle M in the parking lot PA.

The action plan generation unit 130 generates an action plan for the vehicle M. Specifically, the action plan generation unit 130 generates a target track on which the vehicle M will travel in the future as an action plan of the vehicle M. The target track is, for example, information in which points (track points) to be reached by the vehicle M are arranged for each predetermined traveling distance (for example, about several [m]). Further, the target track may include information on speed elements such as the target speed and the target acceleration of the vehicle M at each predetermined time or at each track point. The action plan generation unit 130 generates an action plan according to the instructions of the parking lot management device 400 received by the communication device 30, for example.

The action control unit 140 controls the vehicle M to act according to the action plan generated by the action plan generation unit 130. Specifically, the action control unit 140 controls the traveling driving force output device 200, the brake device 210, and the steering device 220 so that the vehicle M passes the target track generated by the action plan generation unit 130 at the scheduled time. The action control unit 140 controls, for example, the traveling driving force output device 200 and the brake device 210 based on the speed element associated with the target track and controls the steering device 220 according to a curvature degree of the target track.

The status recognition unit 150 recognizes an internal state of the vehicle M. Specifically, the status recognition unit 150 recognizes something left behind which is left in a passenger compartment of the own vehicle M. Specifically, the status recognition unit 150 extracts a difference between two images based on, fir example, a past passenger compartment image captured by the camera 11 and a passenger compartment image captured when an occupant disembarks. The past image of the passenger compartment is, for example, an image taken in a state where no occupant is on the own vehicle M and no luggage is loaded on the own vehicle M. The feature data of the past passenger compartment image or the image drawn for comparison is stored in a storage device (not illustrated). When the difference is drawn in the two images or the feature data thereof, the status recognition unit 150 recognizes an object existing in a place where the difference occurs as something left behind.

Further, the status recognition unit 150 recognizes a possible travel distance of the own vehicle M. More specifically, the status recognition unit 150 recognizes the possible travel distance of the own vehicle M based on, for example, the remaining battery amount detected by a battery remaining amount detecting unit (not illustrated) and the information indicating the electric power efficiency of the own vehicle M.

In addition, the status recognition unit 150 recognizes an occupant in the passenger compartment of the own vehicle M. More specifically, the status recognition unit 150 recognizes an occupant existing in the passenger compartment of the own vehicle M, for example, by the presence or absence of an image (face image or the like) of a person included in the passenger compartment image captured by the camera 11.

The recognition result by the status recognition unit 150 is transmitted to the parking lot management device 400 as information relating to the vehicle M. The information relating to the vehicle M includes information (hereinafter, also referred to as left-behind thing information) on whether something left behind is left in the passenger compartment of the vehicle M, information (hereinafter, also referred to as possible travel distance information) on the possible travel distance based on the remaining energy amount of the vehicle M, and information (hereinafter, also referred to as occupant existence information) on whether there is an occupant in the passenger compartment of the vehicle M.

Each functional unit included in the automatic driving control device 100 is realized, for example, by the Central Processing Unit (CPU) executing a predetermined program (software). Further, a part or all of the functional units of the automatic driving control device 100 may be realized by hardware such as Large Scale Integration (LSI), Application Specific Integrated. Circuit (ASIC), Field-Programmable Gate Array (FPGA). Graphics Processing Unit (GPU), and for example, the storage device for storing the second map information 160 and the high-precision position recognition unit 120 may be realized by a Map Positioning Unit (MPU). Further, a part or all of the functional units included in the automatic driving control device 100 may be realized by the cooperation of software and hardware.

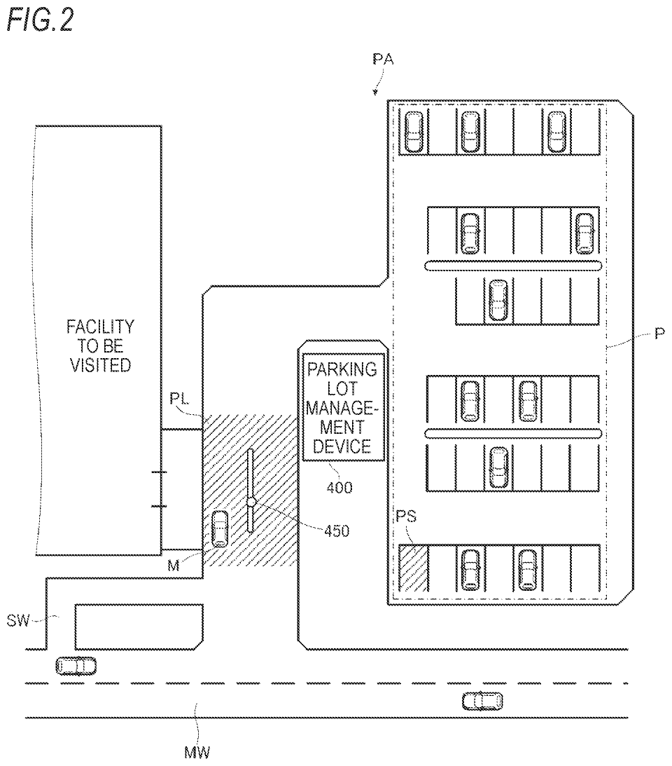

Next, an example of the parking lot PA will be described with reference to FIG. 2. The parking lot PA illustrated in FIG. 2 is an automatic valet parking type parking lot attached to a visited facility to be visited by a user and is managed by the parking lot management device 400. The parking lot PA includes a parking area P and a platform PL provided right before the parking area P. The parking area P is an area in which the parking lot management device 400 determines and manages a destination of the vehicle M and manages a location of the vehicle M. The parking area P is provided with a plurality of parking spaces PS in which vehicles can be individually parked.

The platform PL is provided with an image pickup device 450 which monitors a vehicle which stops or passes through the platform PL. The image pickup device 450 is, for example, a digital camera or a digital video using a solid-state image sensor such as a CCD or CMOS, and periodically transmits images and videos captured to the parking lot management device 400.

Further, an entrance to a branch road SW is provided right before the platform PL. The branch road SW is connected to a road MW on which the vehicle M which visited the parking lot PA has traveled. A vehicle which has canceled entry to the parking lot PA just before the platform PL can return to the road MW through the branch road SW.

Here, an example when a user of the vehicle M uses the parking lot PA will be described. Before using the parking lot PA, the user of the vehicle M makes a reservation for using the parking lot PA to the parking lot management device 400 which manages the parking lot PA by using the terminal device 300 or the like. This “user” is not limited to the owner or manager of the vehicle M, but includes, for example, a person (for example, a concierge) who performs procedures such as parking reservation on behalf of the owner of the vehicle M. Then, when the reserved date and time arrives, the user of the vehicle M drives the vehicle M to the platform PL and gets off from the vehicle M at the platform PL.

After getting off the vehicle M, the user of the vehicle M requests the parking lot management device 400 to park the vehicle M. For example, the user uses the terminal device 300 to send a start request for a self-propelled entry event to the parking lot management device 400. In response to this start request, the parking lot management device 400 permits or disallows the start of the self-propelled entry event of the vehicle M.

When the start of the self-propelled entry event is permitted, the vehicle M automatically drives and starts the self-propelled entry event to move to the predetermined parking space PS in the parking area P. Specifically, the vehicle M moves to the parking space PS designated by the parking lot management device 400 while receiving guiding by the parking lot management device 400 and sensing with the camera 11, the radar device 12, the finder 13, or the like.

On the other hand, when the start of the self-propelled entry event is not permitted, the vehicle M performs a predetermined behavior (stops at the platform PL, goes around the platform PL, and moves to a predetermined escape area). A user of the vehicle M can know that some event (“There is something left behind”, “The possible travel distance is equal to or less than a reference value”, “There is an occupant”) may have occurred in the vehicle M due to the behavior of the vehicle M. After the event is resolved, the user of the vehicle M sends the start request of the self-propelled entry event to the parking lot management device 400 again by using the terminal device 300.

When the start of the self-propelled entry event is permitted by the request to start the self-propelled entry event again, the vehicle M automatically drives and starts a self-propelled entry event where the vehicle M moves to the parking space PS in the parking area P.

On the other hand, when the start of the self-propelled entry event is not permitted even in response to the request to start the self-propelled entry event again, a message instructing to exit from the parking lot PA is displayed on a screen of the navigation device 40 of the vehicle M or a display provided in the parking lot PA. The user of the vehicle M leaves the parking lot PA by, for example, making a U-turn on the vehicle M at the platform PL.

In addition, at the time of exit from the parking lot PA, the vehicle M automatically drives and performs a self-propelled exit event to move from the parked parking space PS to the platform PL. For example, a user uses the terminal device 300 or the like to send a start request for a self-propelled exit event to the parking lot management device 400. In response to this start request, the parking lot management device 400 instructs the vehicle M to perform a self-propelled exit event in which the vehicle M moves from the parking space PS where the vehicle M is parked to the platform PL. According to this instruction, the vehicle M moves to the platform PL while receiving guiding by the parking lot management device 400 and sensing with the camera 11, the radar device 12, the tinder 13, or the like. The user gets on the vehicle M at the platform PL and exits from the parking lot PA. At the time of exit, the user may manually drive the vehicle M.

Further, the vehicle M may carry out re-parking, so-called “reparking”, in which the parking position is changed to another parking position while parking at the parking lot PA. This reparking is appropriately carried out by a control instruction by the parking lot management device 400 or a voluntary automatic driving by the vehicle M itself.

Next, the parking lot management device 400 will be described. The parking lot management device 400 is a device (computer) which manages the parking lot PA. For example, the parking lot management device 400 determines the parking position of the vehicle entering the parking lot PA or instructs the vehicle to move to the determined parking position.

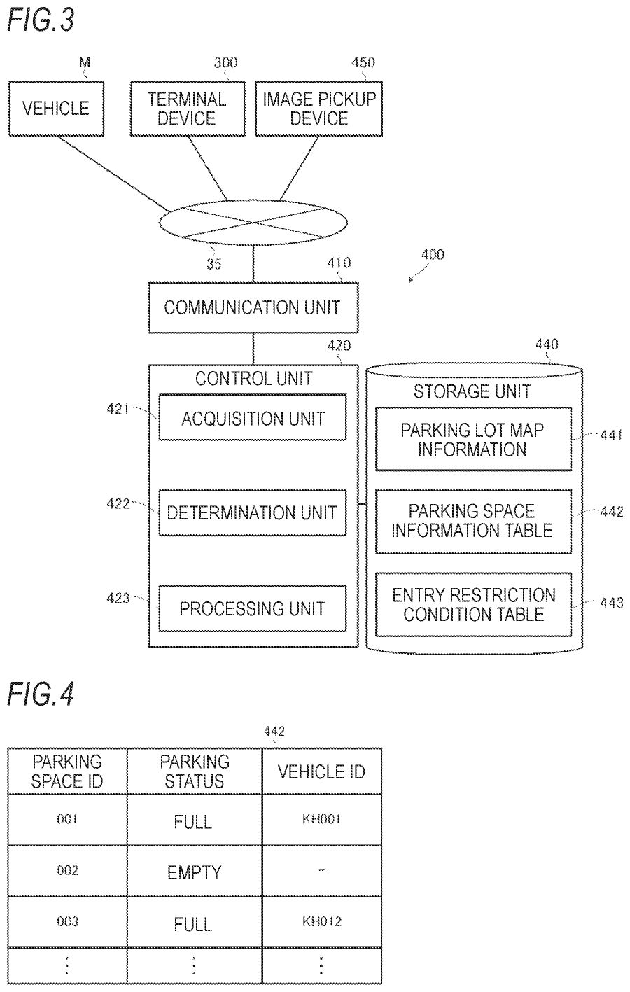

More specifically, the parking lot management device 400 includes a communication unit 410, a control unit 420, and a storage unit 440, as illustrated in FIG. 3. The communication unit 410 and the control unit 420 are realized, for example, by the CPU executing a predetermined program (software) stored in advance. Further, some or all of these functional units may be realized by hardware such as LSI, ASIC, FPGA, GPU, or may be realized by collaboration between software and hardware. The storage unit 440 is realized by an HDD, a flash memory, or the like.

Information such as parking lot map information 441, a parking space information table 442, an entry restriction condition table 443, and the like is stored in the storage unit 440.

The parking lot map information 441 is information which geometrically represents a structure of the parking lot PA and includes, for example, information indicating coordinates (positions) of respective parking spaces PS.

As illustrated in FIG. 4, the parking space information table 442 stores, for example, information in which a parking space ID, a parking status, and a vehicle ID are associated with each other. Here, the parking space ID is an identifier (identification information) which identifies each parking space PS. The parking status indicates whether any vehicle is parked in the corresponding parking space PS. The parking status is, for example, “full” when a vehicle is parked and “empty” when no vehicle is parked. The vehicle ID is an identifier of each vehicle as described above. In the parking space information table 442, the vehicle ID is stored in association with the parking space PS in which the parking status is “full” and indicates the vehicle parked in the parking space PS.

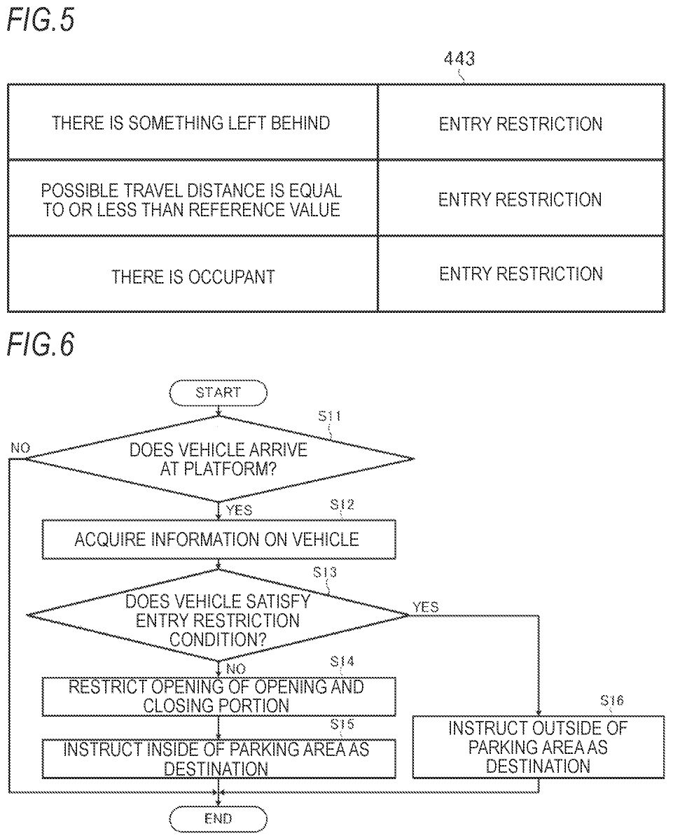

As illustrated in FIG. 5, the entry restriction condition table 443 stores a plurality (three in this example) of events (“There is something left behind”, “The possible travel distance is equal to or less than a reference value”, “There is an occupant”) which may occur in the vehicle in association with information (“Entry restrictions”) indicating that the entry of the vehicle into the parking area P is restricted when each event occurs.

The communication unit 410 communicates with the vehicle M, the terminal device 300, and the image pickup device 450 wirelessly or by wire (for example, network 35). The control unit 420 includes an acquisition unit 421, a determination unit 422, and a processing unit 423. The control unit 420 controls the behavior of the vehicle M based on the information acquired via the communication unit 410 and the information stored in the storage unit 440.

The process performed by the control unit 420 includes a process of recognizing an occupant existing in the passenger compartment of the own vehicle M based on the image of a person included in the image of the passenger compartment portion of the vehicle M captured by the image pickup device 450. That is, the image pickup device 450 functions as a status acquisition unit capable of acquiring the state (presence or absence of an occupant existing in the passenger compartment) of the vehicle.

The acquisition unit 421 acquires information (left-behind thing information, possible travel distance information, occupant existence information) relating to the vehicle M. The occupant existence information includes information based on a result of an occupant recognition process by the control unit 420 itself.

By referring to the entry restriction condition table 443 based on the left-behind thing information, the possible travel distance information, and the occupant existence information included in the information relating to the vehicle M acquired by the acquisition unit 421, the determination unit 422 determines whether the vehicle M satisfies the condition (hereinafter, also referred to as an entry restriction condition) for not allowing entry to the parking area P. More specifically, when the acquired left-behind thing information indicates that “there is something left behind”, the determination unit 422 determines that the vehicle M satisfies the entry restriction condition by referring to the entry restriction condition table 443.

Also, when the acquired possible travel distance information indicates that “The possible travel distance is less than or equal to a reference value”, the determination unit 422 determines that the vehicle M satisfies the entry restriction condition by referring to the entry restriction condition table 443. Also, when the acquired occupant existence information indicates that “There is an occupant”, the determination unit 422 determines that the vehicle M satisfies the entry restriction condition by referring to the entry restriction condition table 443. That is, when any of the conditions listed in the entry restriction condition table 443 of FIG. 5 is satisfied, it is determined that the vehicle M satisfies the entry restriction condition.

When it is determined that the vehicle M satisfies the entry restriction condition, the processing unit 423 instructs the vehicle M to set the outside the parking area P as a destination. This instruction includes, for example, an instruction to stop the vehicle M at the platform PL, an instruction to make the vehicle M go around the platform PL, an instruction to keep the vehicle M in the platform PL, and further, an instruction to move the vehicle M to a predetermined waiting area in the parking lot PA (but outside the parking area P). As a result, it is possible to prevent the vehicle M which satisfies the entry restriction condition from entering the parking area P and to manage the parking area P appropriately.

More specifically, when there is something left behind in the passenger compartment of the vehicle M, it is determined that the vehicle M satisfies the entry restriction condition and the entry to the parking area P is suppressed. That is, the vehicle M does not move to the parking area P, for example, stops at the platform PL, goes around the platform PL, moves to a predetermined waiting area, and so on. As a result, it is possible to prevent the vehicle M, which has something left behind in the passenger compartment, from entering the parking area P, and to manage the parking area P appropriately. Then, a user who has left something in the vehicle M can take out the something left behind from the vehicle M before the vehicle M moves to the parking space PS. On the other hand, when the vehicle M parks in the parking space PS and then a user who was on the vehicle M notices that he or she has left something in the passenger compartment, it is necessary to move the vehicle M from the parking space PS to the platform PL to take something left behind. Therefore, the number of times the vehicle enters and exits the parking space PS will increase, and thus the management difficulty of the parking area P will increase.

Further, when there is an occupant who has not disembarked from the vehicle M, the vehicle M is determined to satisfy the entry restriction condition and the entry to the parking area P is suppressed. That is, the vehicle M behaves such as stopping at the platform PL without moving to the parking area P. As a result, it is possible to prevent the vehicle M, which has an occupant in the passenger compartment, from entering the parking area P, and to appropriately manage the parking area P. Then, the occupant can be disembarked from the vehicle M before the vehicle M moves to the parking space PS. For example, even when an occupant (such as a parent of an infant) gets off the vehicle M without noticing that, for example, the infant sitting in a back seat or the like of the vehicle M has not got off, the infant and the like can be disembarked from the vehicle M before the vehicle M moves to the parking area P. On the other hand, when the vehicle M enters the parking space PS even though there is an occupant in the passenger compartment of the vehicle M, a personnel of the parking lot PA will have to rush to deal with the parking space PS where the vehicle M is parked, or move the vehicle M from the parking space PS to the platform PL. As a result, the management difficulty of parking area P will increase.

Further, when the possible travel distance of the vehicle M is equal to or less than the reference value, it is determined that the vehicle M satisfies the entry restriction condition and the entry to the parking area P is suppressed. As a result, it is possible to prevent the vehicle M from moving to the parking area P when the possible travel distance is equal to or less than the reference value, and thus it is possible to manage the parking area P appropriately. For example, when the vehicle M, whose possible travel distance is low, moves to the parking area P, the vehicle M becomes inoperable during or after entering the parking space PS, there is a possibility that the movement of other vehicles in the parking area P may be hindered, or it may be difficult for the vehicle M to exit from the parking space PS. However, by suppressing the entry of the vehicle M which satisfies the entry restriction condition into the parking area P, it is possible to prevent such an inconvenient situation from occurring.

Further, when it is determined that the vehicle M does not satisfy the entry restriction condition, the processing unit 423 can instruct the vehicle M to a destination in the parking area P (for example, any parking space PS). In this way, by instructing the vehicle which does not satisfy the entry restriction condition, that is, the vehicle which satisfies the condition that allows entry to the parking area P, to the destination in the parking area P, only vehicles which have nothings left behind or occupant in the passenger compartment and have a sufficient possible travel distance can enter the parking area P. This suppresses the occurrence of troubles such as things left behind or occupants left in the passenger compartment of a vehicle parked in the parking space PS or the vehicle entering the parking space PS runs out of battery. As a result, the parking area P can be effectively used.

In addition, it is conceivable that it is not preferable to allow the vehicle M to enter the parking area P due to circumstances on the parking lot PA side (for example, there is no space in parking area P, there is a broken vehicle, or the like). Therefore, even when the vehicle M does not satisfy the entry restriction condition, when it is not preferable to allow the vehicle M to enter the parking area P due to the circumstances of the parking lot PA side, the processing unit 423 may not instruct the vehicle M to the destination in the parking area P. In this way, it is possible to prevent the vehicle M from entering the parking area P in a situation where it is not preferable to allow the vehicle M to enter the parking area P.

Further when the vehicle M is moved in the parking area P, the processing unit 423 limits the opening of an opening and closing portion (door, window, or the like) provided in the vehicle M. As a result, it is possible to effectively utilize the parking area P by suppressing the occurrence of troubles caused by the opening of the door or the like of the vehicle M while the vehicle M is moving in the parking area P.

According to the embodiment described above, the parking area P is an area in which the parking lot management device 400 determines and manages the destination of the vehicle and manages the location of the vehicle M. Therefore, by suppressing the vehicle M, which may cause the trouble described above, from entering the parking area P, it is possible to facilitate the management of the parking area P by the parking lot management device 400.

Further, according to the embodiment described above, the parking lot management device 400 recognizes the status of the vehicle M based on the image captured by the image pickup device 450 provided in the parking lot PA, and then based on the recognition result, it is possible to determine whether to suppress the entry of the vehicle M into the parking area P. Thereby, the behavior of the vehicle M can be controlled by the determination of the parking lot management device 400 without the information and the determination from the vehicle M, and thus the parking area P can be appropriately managed.

Further, according to the embodiment described above, the status recognition unit 150 of the vehicle M recognizes the status of the own vehicle M based on the image captured by the camera 11 included in the vehicle M, and then based on the recognition result, the parking lot management device 400 can determine whether to suppress the entry of the vehicle M into the parking area P. As a result, while simplifying the equipment of the parking lot PA, the behavior of the vehicle M can be controlled by the determination of the parking lot management device 400, and thus the parking area P can be appropriately managed.

Next, an example of a vehicle entry control process performed by the parking lot management device 400 will be described with reference to FIG. 6. The parking lot management device 400, for example, performs the process illustrated in FIG. 6 at a predetermined cycle.

As illustrated in FIG. 6, the parking lot management device 400 determines whether the vehicle M has arrived at the platform PL (Step S11). When it is determined that the vehicle M has not arrived at the platform PL (NO in Step S11), the parking lot management device 400 ends the process illustrated in FIG. 6. When it is determined that the vehicle M has arrived at the platform PL (YES in Step S11), the parking lot management device 400 acquires the information relating to the vehicle M (Step S12).

Next, the parking lot management device 400 determines whether the vehicle M satisfies the entry restriction condition by referring to the entry restriction condition table 443 based on the information relating to the vehicle M (Step S13). When the vehicle M does not satisfy the entry restriction condition (NO in Step S13), the parking lot management device 400 restricts the opening of the opening and closing portion (door, window, or the like) included in the vehicle M (Step S14).

Next, the parking lot management device 400 instructs the vehicle M to set the inside of the parking area. P as the destination (Step S15). As a result, only vehicles which satisfy the conditions for permitting entry into the parking area P can enter the parking area P. In this case, there is no trouble caused by opening the opening and closing portion of the vehicle moving in the parking area P.

On the other hand, when the vehicle M satisfies the entry restriction condition (YES in Step S13), the parking lot management device 400 instructs the vehicle M to set the outside of the parking area P as the destination (Step S16). As a result, it is possible to prevent troubles caused by vehicles which are not permitted to enter the parking area P entering the parking area P, and thus it is possible to manage the parking area P efficiently and appropriately.

In the example described above, when the vehicle M satisfies the entry restriction condition, by instructing the vehicle M to the outside of the parking area P as the destination, for example, the vehicle M is stopped at the platform PL to prevent the vehicle M from entering the parking area P. However, the invention is not limited to this. For example, when the vehicle M satisfies the entry restriction condition, the vehicle M may be prevented from entering the parking lot PA itself by instructing the vehicle M to the outside of the parking lot PA as a destination.

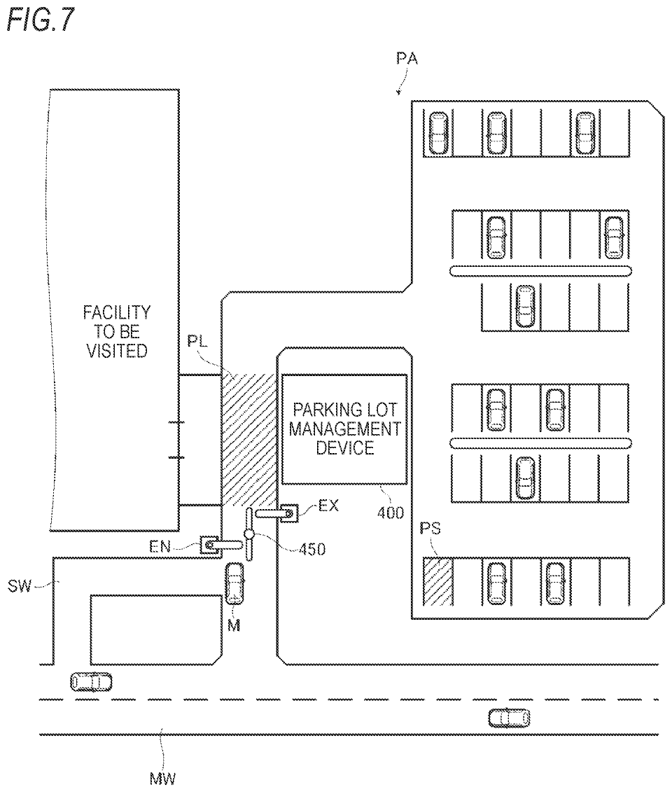

FIG. 7 illustrates another example of the parking lot PA managed by the parking lot management device 400. In FIG. 7, the same reference numerals and letters are given to the parts common to those in FIG. 2 and the description thereof will be omitted as appropriate. In the example of FIG. 7, an entrance gate EN that the vehicle passes through when entering the parking lot PA and an exit gate EX that the vehicle passes through when exiting from the parking lot PA are provided right before the platform PL of the parking lot PA. A vehicle (for example, a vehicle paused right before the entrance gate EN) entering the entrance gate EN and a vehicle exiting from the exit gate EX are monitored by the image pickup device 450. The image pickup device 450 periodically transmits images and videos captured to the parking lot management device 400. The parking lot management device 400 may use the recognition result of image analysis of the image or video captured by the image pickup device 450 to acquire information on the vehicle M. Further, an entrance to the branch road SW is provided right before the entrance gate EN of the parking lot PA in this case.

In the case of the example of FIG. 7, the parking lot management device 400 pauses the vehicle M right before the entrance gate EN, for example, and acquires the information on the vehicle M. Then, the parking lot management device 400 determines whether the vehicle M satisfies the entry restriction condition (for example, whether the possible travel distance is equal to or less than the reference value), and then when the vehicle M satisfies the entry restriction condition, the parking lot management device 400 instructs the vehicle M to set the outside of the parking lot PA as a destination. For example, when the vehicle M satisfies the entry restriction condition, the parking lot management device 400 instructs the vehicle M to return to the road MW through the branch road SW without opening the entrance gate EN. As a result, it is possible to prevent the vehicle M which satisfies the entry restriction condition from entering the parking lot PA itself, and thus it is possible to manage the parking lot PA appropriately.

Further, the parking lot management device 400 instructs the vehicle M to set the inside of the parking lot PA as the destination when the vehicle M does not satisfy the entry restriction condition. For example, when the vehicle M does not satisfy the entry restriction condition, the parking lot management device 400 opens the entrance gate EN and instructs the vehicle M to move to the platform PL. In this case, the vehicle M performs automatic driving and moves to the platform PL. In this case, the user's operation on the vehicle M may be invalidated. In this way, it is possible to prevent the smooth movement to the platform PL from being hindered by an erroneous operation by the user.

The invention is not limited to the embodiment described above and can be appropriately modified, improved, and the like. For example, in the embodiment described above, an example in which the moving body is a vehicle is described, but the invention is not limited to this. The idea of the invention can be applied not only to a vehicle but also to a robot, a ship, an aircraft, and the like which have a drive source and can move by the power of the drive source. Similarly, the accommodation area may be a hangar, a berth, a parking apron, or the like. In addition, automatic driving is a concept which includes autonomous movement.

Further, in the embodiment described above, a case where the presence of something left behind in the passenger compartment of the own vehicle M is recognized based on the image captured by the camera 11 of the own vehicle M is described. However, the invention is not limited to this. For example, the presence of something left behind or an occupant may be recognized based on a detection result of a detection unit which detects a vehicle weight of the own vehicle M. In addition, when the left-behind thing (for example, a mobile terminal device) has a communication function using a non-contact chip such as Radio Frequency Identifier (RFID) authentication, even after an occupant has disembarked from the own vehicle M, if the something left behind and the automatic driving control device 100 are still communicating by the communication function, the status recognition unit 150 may recognize that something left behind is left in the own vehicle M.

Further, in the embodiment described above, as conditions for suppressing the entry of the vehicle M into the parking area P, it is exemplified that a case where there is something left behind, a case where the possible travel distance is equal to or less than the reference value, and a case where there is an occupant. However, the invention is not limited to those. For example, the detection of a failure of a detection device included in the vehicle M such as the camera 11, the radar device 12, the finder 13, and the like may be included in the condition for suppressing the vehicle from entering the parking area P. Based on the information input via the detection device, the vehicle M autonomously moves while recognizing the state of position, speed, acceleration, and the like of an object around the own vehicle M. Therefore, by suppressing the entry of the vehicle M, whose detection device is out of order, into the parking area P, it is possible to prevent the occurrence of troubles caused by the vehicle M, which may interfere with autonomous movement, entering the parking area P. As a result, it is possible to manage the parking area P appropriately.

In addition, at least the following matters are described in this specification. The components and the like corresponding to those of the embodiment described above are shown in parentheses, but the invention is not limited thereto.

(1) An accommodation area management device (parking lot management device 400) which manages an accommodation area (parking area P, parking lot PA) capable of accommodating a moving body (vehicle M), including:

an acquisition unit (acquisition unit 421) configured to acquire information on the moving body;

a determination unit (determination unit 422) configured to determine whether the moving body satisfies a condition of not allowing entry into the accommodation area based on the information on the moving body; and

a processing unit (processing unit 423) configured to instruct the outside of the accommodation area as a destination when it is determined that the moving body satisfies the condition of not allowing entry into the accommodation area.

According to (1), the moving body which satisfies the condition of not allowing entry into the accommodation area is instructed to the outside of the accommodation area as the destination. Therefore, it suppresses the moving body from entering the accommodation area, and thus it is possible to manage the accommodation area appropriately.

(2) The accommodation area management device according to (1), where

the processing unit is configured to instruct the moving body to set the inside of the accommodation area as a destination when it is determined that the moving body does not satisfy the condition.

According to (2), the moving body which does not satisfy the condition of not allowing entry into the accommodation area, that is, the moving body which satisfies the condition of permitting entry into the accommodation area can be instructed to the inside of the accommodation area as the destination. Therefore, the moving body can be made to enter the accommodation area, and thus the accommodation area is effectively utilized.

(3) The accommodation area management device according to (1) or (2), where

the accommodation area is an area in which the accommodation area management device determines and manages the destination of the moving body.

According to (3), by suppressing the entry of the moving body satisfying the condition of not allowing the entry into the accommodation area into the accommodation area where the accommodation area management device determines and manages the destination of the moving body, it is possible to facilitate the management of the accommodation area by the accommodation area management device.

(4) The accommodation area management device according to (3), where

the accommodation area is further an area in which the accommodation area management device manages a location position of the moving body.

According to (4), by suppressing the entry of the moving body satisfying the condition of not allowing the entry into the accommodation area into the accommodation area where the accommodation area management device manages the location position of the moving body, it is possible to facilitate the management of the accommodation area by the accommodation area management device.

(5) The accommodation area management device according to (3) or (4), where

opening of an opening and closing portion (door, window) provided in the moving body is restricted when the moving body is moved in the accommodation area.

According to (5), when the moving body is moved in the accommodation area, the opening of the opening and closing portion provided in the moving body is restricted. Therefore, it is possible to prevent the opening and closing portion from opening during movement in the accommodation area, and thus it is possible to facilitate the management of the accommodation area by the accommodation area management device.

(6) The accommodation area management device according to any one of (1) to (5), where

the information on the moving body is information based on an acquisition result of a status acquisition unit (image pickup device 450) which can acquire a status of the moving body.

According to (6), the information on the moving body is the information based on the acquisition result of the status acquisition unit which can acquire the status of the moving body. Therefore, whether the moving body satisfies the condition of not allowing entry into the accommodation area can be appropriately determined based on the status of the moving body.

(7) The accommodation area management device according to (6), where

the status acquisition unit is a sensor (camera 11) included in the moving body.

According to (7), the status acquisition unit is the sensor included in the moving body. Therefore, while simplifying equipment in the accommodation area, it is possible to appropriately determine whether the moving body satisfies the condition of not allowing entry into the accommodation area.

What is claimed is:

1. An accommodation area management device which manages an accommodation area capable of accommodating a moving body, comprising:
an acquisition unit configured to acquire information on the moving body;
a determination unit configured to determine whether the moving body satisfies a condition of not allowing entry into the accommodation area based on the information on the moving body; and
a processing unit configured to instruct the outside of the accommodation area as a destination when it is determined that the moving body satisfies the condition of not allowing entry into the accommodation area.

2. The accommodation area management device according to claim 1, wherein
the processing unit is configured to instruct the moving body to set the inside of the accommodation area as a destination when it is determined that the moving body does not satisfy the condition.

3. The accommodation area management device according to claim 1, wherein
the accommodation area is an area in which the accommodation area management device determines and manages the destination of the moving body.

4. The accommodation area management device according to claim 3, wherein
the accommodation area is further an area in which the accommodation area management device manages a location position of the moving body.

5. The accommodation area management device according to claim 3, wherein
opening of an opening and closing portion provided in the moving body is restricted when the moving body is moved in the accommodation area.

6. The accommodation area management device according to claim 1, wherein
the information on the moving body is information based on an acquisition result of a status acquisition unit which can acquire a status of the moving body.

7. The accommodation area management device according to claim 6, wherein
the status acquisition unit is a sensor included in the moving body.
